(19) United States
(12) Patent Application Publication
(10) Pub. No.: US 2008/0047009 A1
(43) Pub. Date: Feb. 21, 2008

(54) SYSTEM AND METHOD OF SECURING NETWORKS AGAINST APPLICATIONS THREATS

(76) Inventors: Kevin Overcash, Carlsbad, CA (US); Kate Delikat, Natanya (IL); Rami Mizrahi, Rishon LeZion (IL); Galit Efron (Njtzan), Ramat Hasharon (IL); Doron Kolton, Pardesia (IL); Asaf Wexler, Ra'anana (IL); Netta Gavrieli, Ramat Gan (IL); Yoram Zahavi, Zichron LeZion (IL)

Correspondence Address: PROCOPIO, CORY, HARGREAVES & SAVITCH LLP, 530 B STREET, SUITE 2100, SAN DIEGO, CA, 92101, US

(21) Appl. No.: 11/458,965

(22) Filed: Jul. 20, 2006

(51) Int. Cl. G06F 12/14

(52) U.S. Cl. 726/23

(57) ABSTRACT

A system and method for protection of Web based applications are described. A Web application security system is included within a computer network to monitor traffic received from a wide area network, such as the Internet, and determine if there is a threat to the Web application. The Web application security system monitors web traffic in a non-inline configuration and identifies any anomalous traffic against a profile that identifies acceptable behavior of a user of the application. Any anomalous traffic is analyzed and appropriate protective action is taken to secure the Web application against an attack.

### BACKGROUND

1. Field of the Invention

This invention relates to computer network security, and more particularly securing Web applications.

2. Description of Related Art

Recent, well publicized, security breaches have highlighted the need for improved security techniques to protect consumer privacy and secure digital assets. Examples of organizational victims of cybercrime include well known companies that typically have traditional Web security in place, yet cyber criminals have still been able to obtain personal data from financial, healthcare, retail, and academic Web sites. Organizations that have publicly confirmed exposure of client or customer information put the figure at over 500,000 people who were victims of cybercrime in 2005, and those are the organizations that have publicly confirmed a security breach. It is highly likely that more organizations were also impacted, by did not reported it, and more troubling yet, other organizations may have had information leakage but are completely unaware of the situation.

Organizations can not afford negative brand image, credibility damage, legal consequences, or customers losses. In one example, in June 2005 MasterCard and Visa reported that a third part processor, CardSystems, had exposed credit card transaction records of approximately 40 million people that included names, card numbers and security codes. The CardSystems situation is an unfortunate example of how a single security breach can materially impact a business, yet it is also a wake up call for anyone doing business online.

The disclosure of some of these Web security breaches has led law enforcement to determine, after careful investigation, that cybercrime is being driven by organized crime. This is very different than the bright kid-next-door trying to break into a system to prove bragging rights. Targeted rings of well educated and sophisticated hackers have been uncovered, often in countries where prosecuting them is a challenge. Contributing to the increase in cybercrime is the ease with which these organized cyber criminals can target, and hack, a Web application from anywhere in the world with simple Internet access.

Properly securing Web applications and the data behind them is a critical component to doing business on the Web. Often, some of the most valuable organizational data is served through a Web browser making it more important than ever to safeguard this information from cybercriminals.

Thus, there is a need for improved systems and techniques to protect Web applications from security breaches.

### SUMMARY

Techniques for protection of Web based applications are described. A Web application security system is included within a computer network to monitor traffic received from a wide area network, such as the Internet, and determine if there is a threat to the Web application. The Web application security system is adapted to monitor web traffic in a non-inline configuration. In other words, the Web application security system is a module that monitors Web traffic through a mirror port, or other device, so that the main flow of web traffic does not flow through the module. Because the Web application security module is not inline, there is no latency added to the web traffic.

Techniques described herein provide protection of high-value Web applications and the data behind them from targeted Web-based attacks are described. The Web application security system, or security appliance, provides comprehensive Web application protection through an architecture designed to address the spectrum of modern Web application threats. Behavior-based security profiles are created, automatically or manually, and maintained for each Web application thereby enabling the security system to ensure that unique application vulnerabilities are successfully addressed. This positive security model ensures that only acceptable behaviors are allowed, thereby protecting against even unknown threats to the application.

In one embodiment, Web traffic undergoes passive SSL decryption to ensure that any attacks within SSL traffic are detected. Traffic is then analyzed by multiple threat-detection engines that enable identification and in-context security analysis of security anomalies. Flexible security policies are used to determine what actions to take if anomalies are uncovered. A management console allows for ease of setup and maintenance while providing detailed even analysis on an on-going basis. Centralized Web application threat intelligence is delivered with an easy to deploy out-of-line security appliance. Because the security system is not in-line, it has minimal impact on the network and introduces no application delivery latency into the production network environment. The security system can also leverage best-of-breed network devices for distributed threat management allowing organizations to manage Web application security in the same manner that the applications themselves are managed.

The Web application security module can include a collaborative detection module that includes multiple threat detection engines. One threat detection engine, referred to as a behavioral analysis engine, monitors all Web traffic. The behavioral analysis engine evaluates the Web traffic based upon a profile of expected, or acceptable, Web traffic for a particular application. If the behavioral analysis determines that there are any anomalies in the Web traffic, then the traffic will be analyzed by one or more of the other threat detection engines. The behavioral analysis can be based upon a positive model that checks behavior against an acceptable behavior model, and if the behavior does not fit the acceptable model, it is identified as an anomaly. Likewise, the behavior analysis can be based upon a positive model and if the behavior fails that model, the behavior can then be checked against a negative model that identifies all known unacceptable behavior to identify if the behavior matches a known unacceptable behavior to further aid in determining an appropriate response.

Other threat detection engines that can be included in the collaborative detection module include, for example, a signature analysis engine, a protocol violation engine, a session manipulation engine, a usage analysis engine, an exit control engine, and a web services analysis engine.

The Web application security module also includes an adaption module. During an initial deployment of an application, or deployment of an update of an application, the adaption modules monitors Web traffic to develop a profile of normal, or acceptable, traffic during user interaction with the application. After the profile has been developed, it can then be used by the collaborative detection module to determine if there is abnormal traffic between a user and the application. During the life of the application, the adaption module continually monitors Web traffic to update and modify the profile as user interactions with the application change over time. In addition to automatically developing and maintaining the profile, an administrator can provide an initial profile for an application. The administrator can also manually modify a profile at any time. For example, if an administrator becomes aware of a new signature used to attack applications similar to the application being profiled, the administrator can manually update the profile rather than wait for the adaption to learn the new signature automatically.

Using behavior-based security profiles that are created and maintained for each Web application ensures that vulnerabilities that are unique to an application are successfully addressed. A positive security model ensures that only acceptable behaviors are allowed, thereby protecting against even unknown threats to the application.

The results from the collaborative detection module are communicated to an advanced correlation engine (ACE). The ACE analyzes the results from the various threat detection engines and determines if there is a threat. For example, there may be several protocol violation events, none of which alone would raise a security issue, but by correlating these low level events the ACE may determine that there is sufficient suspicious behavior to take preventive action. In addition, the ACE may correlate events from several different threat detection engines to determine if there is a threat. That is, there could be different combinations of events that the ACE would correlate and identify as a threat. For example, the combination of usage analysis events with particular exit control events can lead to a determination that there is a threat.

A set of security policies can be used by the ACE to assist in determining what set of events should be identified as a potential threat. In addition, the security policies can identify what actions to take in the event that there is a threat. For example, the security policy could provide procedures to follow in response to different types of events, such as to log that the events have occurred, to notify an administrator that an event has occurred, or to initiate some type of preventive procedure.

The Web application security module also includes a database for storing information about the occurrence of events. The information stored in the database can also be used to generate reports and to provide information to an event viewer display to notify an administrator about the events.

Other features and advantages of the present invention should be apparent from the following description which illustrates, by way of example, aspects of the invention.

### BRIEF DESCRIPTION OF THE DRAWINGS

FIG. 1 is a block diagram of an exemplary system configured in accordance with aspects of the invention.

FIG. 2 is a block diagram illustrating aspects of an exemplary embodiment of a Web application protection system which can be carried out by the Web application protection module of FIG. 1.

FIG. 3 is a block diagram of illustrating further detail of an exemplary dataflow in a Web application security technique as may be performed by the Web application protection module of FIG. 1.

FIG. 4 is a display of an exemplary site manager display generated by the manager console, designed to enable interaction with the application profiles.

FIG. 5 is a display of an exemplary policy manager display generated by the manager console, designed to enable interaction with the security policies.

FIG. 6 is a display of an exemplary event viewer display generated by the manager console, designed to enable interaction with the detected security events.

FIG. 7 is a flow chart illustrating an exemplary technique for preventing a SQL Injection attack.

### DETAILED DESCRIPTION

The following detailed description is directed to certain specific embodiments of the invention. However, the invention can be embodied in a multitude of different systems and methods. In this description, reference is made to the drawings wherein like parts are designated with like numerals throughout.

### Need for Increased Security

In response to increased cybercriminal activity, government regulations for privacy and accountability mandate a standard of security, and customer notification if personal data is lost or stolen. In the U.S., many states have enacted a form of the Information Security Breach Act and other states have similar pending privacy legislation. As new disclosure standards emerge, consumers expect to be notified in the event of a security breach. Organizations are motivated by government regulations or consumer expectations to incorporate the necessary security measures to safeguard data. Organizations also desire to demonstrate, through security audits, that reasonable due care is taken to protect customer and financial information and that customers are notified in the event of a data theft or loss.

Some industries, such as the credit card industry, have created their own security standards to proactively address the need for managing customer data more securely and consistently. The Payment Card Industry (PCI) Data Security Standard requires Master-Card merchants to protect cardholder data, encrypt transmissions and stored data, and develop and maintain secure systems and applications. (See “Payment Card Industry Data Security Standard” at URL https://sdp.mastercardintl.com/pdf/pcd_manual.pdf (January 2005).

Similarly, the VISA Cardholder Information Security Program (CISP) requires compliance to its standards for all entities storing, processing, or transmitting cardholder data. For example, VISA merchants must prove CISP compliance, follow outlined disclosure policies in the event of data theft of loss, and are subject to hefty financial penalties (up to $500,000 per incident) for non-compliance. (See “VISA Cardholder Information Security Program” at URL http://usa.visa.com/business/accepting_visa/ops_risk_management/cisp_merchants.html.)

Because the number of notification laws to be enacted is likely to increase, organizations are motivated to improve and validate existing security measures that protect the organization from Web threats and to demonstrate to regulators and stakeholders that security is interwoven into the business operations.

### Shortcomings in Existing Security Measures

The growth in popularity and general acceptance of the Web as a network for commerce and communications has been unprecedented. However, security was not part of the original design of the Web so it is susceptible to security breaches. Further exacerbating the lack of security measures in the original design of the Web, many organizations are aggressively moving applications to the Web that were originally created for an internal network environment. The push to make applications available sometimes outweighs thorough security testing of the applications, and potentially opens the door to unanticipated vulnerabilities being uncovered once the application is available on the Internet.

Before Web applications became so popular sensitive information was typically stored in databases and applications on internal networks. Cybercriminals, such as hackers, wanting to obtain this information would have to gain access to the data by breaking into servers deeper and deeper within an organization's network until they found something useful. Network security solutions, such as firewalls and intrusion detection systems, were designed to meet this threat.

As applications have moved to the Web, hackers have shifted their strategy from attacking organizations by searching for vulnerable servers that can be compromised, to targeted attacks against Web applications. The use of Web applications provides a front-end to an organization's mission-critical data. Hackers no longer need to search through a network to find the data they are looking for, they can now simply browse an organization's Web site. In addition, each of the applications is different and thus, cannot typically be protected by generic measures as was possible for traditional network security solutions. Generally, each Web application requires protective measures tailored to its specific needs.

A common misconception in Web security is that using Secure Sockets Layer (SSL) will protect a Web application from attacks. While SSL supports secure transmission of sensitive information, it does not protect a Web application from attack. Attacks can be sent using SSL and the SSL transmission goes through firewalls because the firewall will usually have a port, typically port 443, open to permit SSL traffic. Using SSL provides protection for data during transmission, but it does not afford protection from attacks against the Web application, such as SQL Injection discussed further below. Many hackers have discovered that by sending attacks through SSL, they can circumvent network security because these network devices are unable to view this encrypted data.

Prior, or first-generation, application protection solutions or application firewalls followed the same paradigm as network firewalls. In these types of solutions, a negative, or list-based, model of application level threats is used to screen for potential application-level attacks. However, because each application is unique, a list-based or negative security model is generally not effective at securing the Web application from attacks. An enhancement to these types of solution is to provide a tailored application security profile. However, manually creating and maintaining a profile limits the practicality of these solutions, particularly in a production environment.

In addition, first-generation application protection solutions are typically configured to be an in-line device. Being an in-line device, the solutions have to ensure that there is no, or minimal, impact to production network operations, including considerations such as traffic latency, the introduction of false positives, and the potential to block a valid transaction.

### Exemplary Aspects of a Web Application Security System

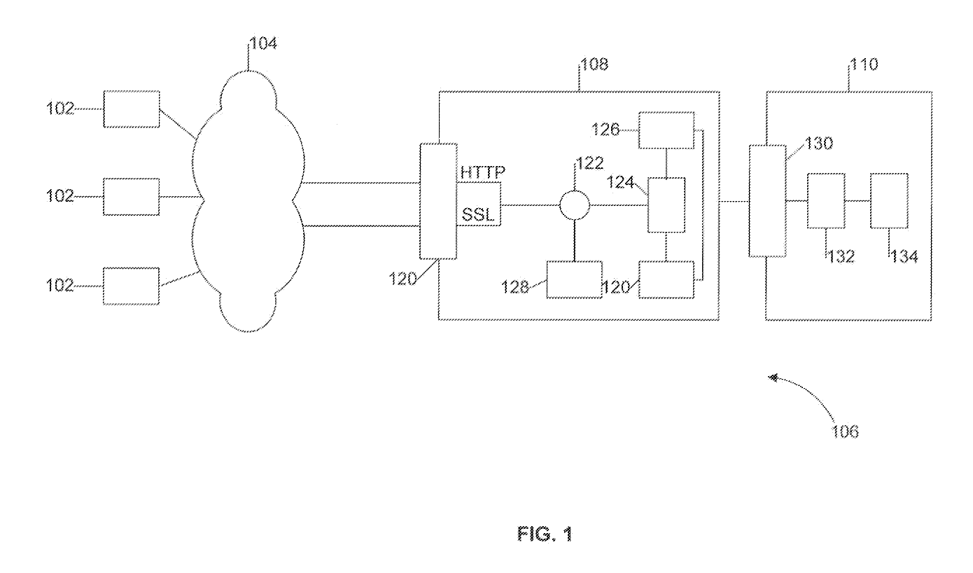

FIG. 1 is a block diagram of an exemplary system configured in accordance with aspects of the invention. As shown in FIG. 1 users 102 are in communication with a wide area network 104. The wide area network 104 may be a private network, a public network, a wired network, a wireless network, or any combination of the above, including the Internet. Also in communication is a computer network 106. A typical computer network 106 may include two network portions, a so called demilitarized zone (DMZ) 108, and a second infrastructure network 110. The DMZ 108 is usually located between the wide area network 104 and the infrastructure network 110 to provide additional protection to information and data contained in the infrastructure network 110.

For example, the infrastructure network 110 may include confidential and private information about a corporation, and the corporation wants to ensure that the security and integrity of this information is maintained. However, the corporation may host a web site and may also desire to interface with users 102 of the wide area network 104. For example, the corporation may be engaged in e-commerce and wants to use the wide area network 104 to distribute information about products that are available to customers, and receive orders from customers. The interface to the wide area network 104, which is generally more susceptible to attacks from cybercriminals is through the DMZ 108, while sensitive data, such as customer credit card information and the like, are maintained in the infrastructure network 110 which is buffered from the wide area network 104 by the DMZ 108.

Examples of components in a DMZ 108 include a firewall 120 that interfaces the DMZ 108 to the wide area network 104. Data transmitted and received from the wide area network 104 pass through the firewall 120, through a mirror port 122 to a load balancer 124 that controls the flow of traffic to Wed servers 126. Also connected to the mirror port 122 is a Web application protection module 128. As described further below, the Web application protection module 128 monitors traffic entering and leaving the DMZ to detect if the Web site is being attacked.

Traffic flows between the DMZ 108 and the infrastructure network 110 through a second firewall 130 that provides additional security to the infrastructure network 110. Components in the infrastructure network 110 can include an application server 132 and a database server 134. Data and information on the application server 132 and database server 134 are provided additional protection from attacks because of the operation of the DMZ.

### Types of Cyber-Crimes

As noted, Web applications are susceptible to attacks from cybercriminal. Generally, attacks against Web applications are attempts to extract some form of sensitive information from the application, or to gain some control over the application and the actions it performs. Hackers target specific organizations and spend time mapping out the Web application and performing attack reconnaissance to determine what types of attacks may be most successful against a specific application.

One way that cybercriminals exploit web applications is a technique referred to as “targeted application attacks.” Because sensitive data is often stored in an application database, the cybercriminals will target their attacks at these databases. Unlike network-level attacks that are successful because network components are identical wherever they are installed, each Web application is unique and hence requires that it be studied to uncover potential weaknesses.

Another technique used by cybercriminals is “parameter tampering/unvalidated input.” To prevent these types of attacks, parameters received by an application should be validated against a positive specification that defines elements of a valid input parameter. For example, elements such as the data type, character set, the minimum and maximum parameter length, enumeration, etc., can be validated. Without some type of control on each parameter an application is potentially open to exploit over the Web.

Still another technique used by cybercriminals is “SQL Injection.” The term SQL Injection is used to refer to attacks that take advantage of a Web application using user input in database queries. In this technique, the cybercriminal will pose as a valid user and enter input in the Web application's form in an attempt to manipulate the Web application into delivering information that is not normally intended to be delivered to the cybercriminal. In this technique, an attacker will usually first map out a Web application site to get an understanding of how it is organized, and identify areas that take input from a user. Many common security defects in Web applications occur because there is no validation of a user's input. If there is no input validation and an application uses a database to store sensitive information, then an attacker, or cybercriminal, can attempt to identify areas within the application that takes a user input to generate a database query, such as looking up a specific user's account information. Attackers can then craft a special data or command string to send the application in the hope that it will be interpreted as a command to the database instead of a search value. Manipulating the special data or command string sent to the application is referred to as an “Injection” attack or “SQL Injection.” An example of an SQL Injection is sending a string command that has been manipulated to request a list all credit card numbers in the database.

Yet another technique used by cybercriminals is “Cross Site Scripting” (XSS). Using XSS, cybercriminals take advantage of Web servers that are designed to deliver dynamic content that allows the server to tune its response based on users' input. Dynamic content has become integral to creating user-friendly sites that deliver content tailored to clients' interests. Examples of such sites include eCommerce sites that allow users to write product reviews. These sites allow users to provide content that will be delivered to other users. Using XSS, a cybercriminal attempts to manipulate a Web application into displaying malicious user-supplied data that alters the Web page for other users without their knowledge.

Typically cross site scripting vulnerabilities occur when Web applications omit input validation before returning client-supplied information to the browser. For example, a Web application may fail to discover that HTML or JavaScript code is embedded in the client input and inadvertently return malicious content to the cybercriminal posing as a user. Because the code appears to come from a trusted site, the browser client treats it as valid and executes any embedded scripts or renders any altered content. Examples of the result of a successful XSS attack can include exposing end user files, installing Trojans, redirecting the user to another Web site or page, and modifying content presented to the user. Victims of an XSS attack may be unaware that they have been directed to another site, are viewing altered content, or worse. Using XSS provides cybercriminals an extremely effective technique for redirecting users to a fake site to capture login credentials, similar to phishing. To effectively secure Web applications and protect users from XSS attacks, user input from dynamically generated content needs to be validated and otherwise handled correctly.

Using technique referred to as “Forceful Browsing” attackers determine if an application uses any scripts or middleware components with known vulnerabilities. Typically, the attacker will type requests for these known vulnerable application components into the URL and determine from the server response whether the vulnerable piece of software is used. The known vulnerabilities are often buffer overflows which provide the attacker with the ability to gain administrative access on the server, at which point they can manipulate the application and its data.

In a another technique referred to as “Improper Error Handling” while mapping out an application and performing attack reconnaissance, attackers will monitor error messages returned by the application. These messages result from errors in the application or one of its components and provide a wealth of information to attackers. Error messages from scripts and components can detail what components and versions are used in the application. Database error messages can provide specific table and field names, greatly facilitating SQL injections. Server error messages and stack traces can help set up buffer overflows, which attackers use to gain administrative access to servers.

In still another technique referred to as “Session Hijacking” attackers focus on session mechanisms to identify any weaknesses in how sessions are implemented. Attackers can manipulate these mechanisms to impersonate legitimate users and access their sensitive account information and functionality.

### Security Model to Protect Web Applications

Typically, network-level devices use a negative security model or “allow all unless an attack is identified.” Network-level devices such as Intrusion Detection and Prevention Systems are effective with this generic negative model because network installations are common across organizations. However, every Web application is different and a generic, or “one-size-fits-all” model for security generally will not work satisfactorily.

A positive, behavior-based security model is generally more effective in securing Web applications. Because each Web application is unique, they expose their own individual sets of vulnerabilities that need to be addressed. A positive behavior-based security model provides protection against threats that are outside the bounds of appropriate, or expected, behavior. Because the security model monitors behavior to determine if it is appropriate, the model can provide protection against unforeseen threats.

To implement a positive, behavior-based security model, a tailored application security profile is created that defines appropriate application behavior. Because a unique security profile is needed for every Web application, manual creation of profiles may be overly burdensome. Instead, it would be beneficial to create security profiles automatically for each application. In addition, it would be beneficial to automate profile maintenance which ensures that application changes are incorporated into the profile on an on-going basis.

As noted, Web applications expose a new set of vulnerabilities that can only be properly understood within the context of the particular application. For example, SQL injection attacks are only valid in areas that take user input. Likewise, forceful browsing attempts can only be determined by understanding the interplay of all the scripts and components that make up the Web application. Further, session manipulation techniques can only be identified by understanding the session mechanism implemented by the application.

To effectively protect a Web application requires understanding how the application works. Thus, generic protection mechanisms, such as those provided by network security devices, are typically inadequate due to a high rate of false positives or attacks missed entirely due to a lack of understanding of where exploitable vulnerabilities are exposed within a specific application.

### Exemplary Embodiments of Web Application Security

In one embodiment of the Web application security system, protection techniques are adapted to address the unique security challenges inherent in Web applications. The techniques fill holes in network-level security, provides tailored application-specific security, and comprehensive protection against an array of potential Web-based threats.

The techniques include combining a behavioral protection model with a set of collaborative detection modules that includes multiple threat detection engines to provide security analysis within the specific context of the Web application. In addition, the techniques reduce the manual overhead encountered in configuring a behavioral model, based upon a profile of typical or appropriate interaction with the application by a user, by automating the process of creating and updating this profile. Further, the techniques include a robust management console for ease of setup and management of Web application security. The management console allows security professionals to setup an application profile, analyze events, and tune protective measures. In addition, the management console can provide security reports for management, security professionals and application developers.

The techniques described further below, allow organizations to implement strong application-level security using the same model that is currently used to deploy the applications themselves. The techniques include additional advantages over other technologies by not requiring an inline network deployment. For example, the techniques have minimal impact on network operations because they can be deployed off of a span port or network tap and does not introduce another point of failure or latency to network traffic.

While the techniques described are not implemented inline, they can prevent attacks against Web applications by interoperating with existing network infrastructure devices, such as firewalls, load balancers, security information management (SIM) and security event management (SEM) tools. Because Web application attacks are typically targeted, and may require reconnaissance, the techniques are adapted to block attacks from a hacker, or cybercriminal, before they are able to gather enough information to launch a successful targeted attack. Various techniques may be combined, or associated, to be able to identify and correlate events that show an attacker is researching the site, thereby giving organizations the power to see and block sophisticated targeted attacks on the application.

Some of the advantages provided by the techniques described include protecting privileged information, data, trade secrets, and other intellectual property. The techniques fill gaps in network security that were not designed to prevent targeted application level attacks. In addition, the techniques dynamically generate, and automatically maintain, application profiles tailored to each Web application. The techniques can also provide passive SSL decryption from threat analysis without terminating an SSL session.

The techniques can also provide flexible distributed protection based upon a distributed detect/prevention architecture (DDPA). Additional protection of customer data is provided by exit control techniques that detect information leakage. A graphical user interface (GUI) can provide detailed event analysis results as well as provide detailed and summary level reports that may be used for compliance and audit reports. Use of various combinations of these techniques can provide comprehensive protection against known, as well as unknown, Web threats.

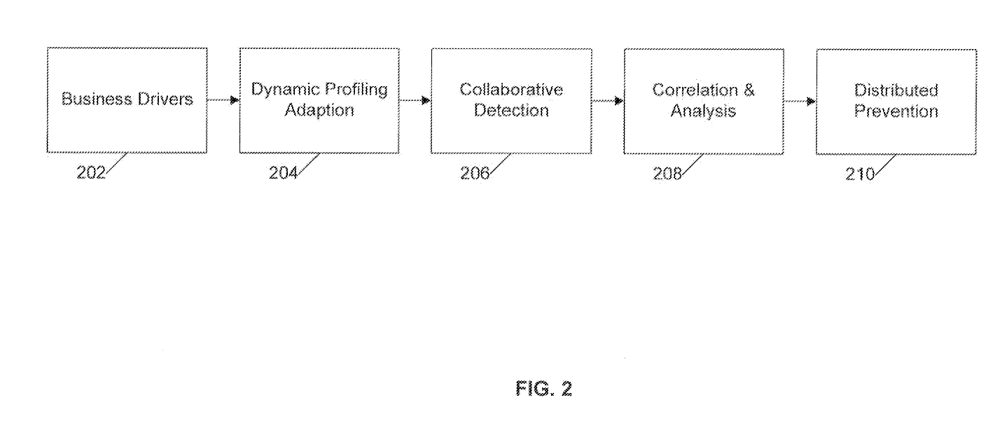

FIG. 2 is a block diagram illustrating aspects of an exemplary embodiment of a Web application protection system which can be carried out by the Web application protection module 128 in FIG. 1. As shown in FIG. 2, a business driver module 202, provides input about the types of threats that are anticipated, and that protection against is sought, or the types of audits or regulations that an entity wants to comply with. Examples, of threats includes identity theft, information leakage, corporate embarrassment, and others. Regulatory compliance can include SOX, HIPAA, Basel LL, GLBA, and industry standards can include PCI/CISP, OWASP, and others. The business driver module 202 provides input to a dynamic profiling module 204.

The dynamic profiling module 204 develops profiles of Web applications. The profiles can take into account the business drivers. The profiles can also be adapted as Web applications are used and users behavior is monitored so that abnormal behavior may be identified. The profiles can also be adapted to identify what types of user input is considered appropriate, or acceptable. The dynamic profiling module provides input to a collaborative detection module 206.

The collaborative detection module 206 uses the input from the dynamic profiling module 204 to detect attacks against a Web application. The collaborative detection module can monitor, and model, a users behavior to identify abnormal behavior of a user accessing a Web application. The collaborative detection module 206 can also monitor user activity to identify signatures of attack patterns for known vulnerabilities in a Web application. Other aspects include protection against protocol violations, session manipulation, usage analysis to determine if a site is being examined by a potential attacker, monitoring out bound traffic, or exit control, as well as other types of attack such as XML virus, parameter tampering, data theft, and denial of services attacks. The collaborative detection module 206 provides the results of its detection to a correlation and analysis module 208.

The correlation and analysis module 208 receives the detection results from the collaborative detection module 206 and performs event analysis. The correlation and analysis module 208 analyses events reported by the collaborative detection module 206 to determine if an attack is taking place. The correlation and analysis module 208 can also correlate incoming requests from users with outgoing response to detect if there is application defacement or malicious content modification being performed. The correlation and analysis module may establish a severity level of an attack based upon a combined severity of individual detections. For example, if there is some abnormal behavior and some protocol violations, each of which by itself may set a low severity level, the combination may raise the severity level indicating that there is an increased possibility of an attack. The output of the correlation and analysis module 208 is provided to a distributed prevention module 210.

The distributed prevention module 210 provides a sliding scale of responsive actions depending on the type and severity of attack. Examples of responses by the distribution prevention module 210 include monitor only, TCP-resets, load-balancer, session-blocking, firewall IP blocking, logging users out, and full blocking with a web server agent. The distribution prevention module 210 can also include alert mechanisms that provide event information to network and security management systems trough SNMP and syslog, as well an email and console alerts.

Using the dynamic profiling module 204, collaborative detection module 206, correlation and analysis module 208, and distributed prevention module 210 provide security for a Web application. Improved Web application security provides protection of privileged information, increased customer trust and confidence, audit compliance, increased business integrity, and brand production.

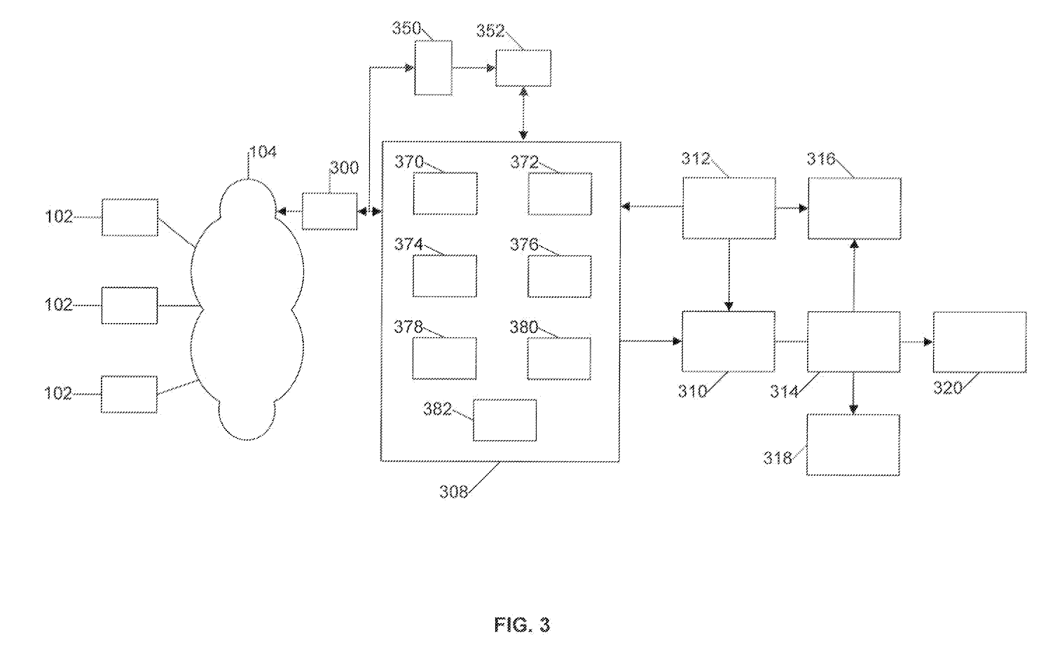

FIG. 3 is a block diagram of illustrating further detail of an exemplary dataflow in a Web application security technique as may be performed by the Web application protection module 128 of FIG. 1. As illustrated in FIG. 3 multiple users 102 are in communication with a wide area network 104, such as the Internet. The users may desire to access a Web application. Typically, a user will access a Web application with web traffic using SSL encryption. A SSL decryption module 306 can passively decrypt the traffic to allow visibility into any embedded threats in the web traffic. The web traffic then flows to a collaborative detection module 308 where the traffic is analyzed in the context of appropriate application behavior compared to the applications' security profile. If an anomaly is discovered, it is passed to one or more of the multiple threat-detection engines included within the collaborative detection module 308. The results from the collaborative detection module 308 are communicated to an Advanced Correlation Engine (ACE) 310 where it is determined the threat context and to reduce false positives. In addition, the collaborative detection module 308 monitors outbound traffic as well as inbound traffic to prevent data leakage such as Identity Theft.

### Advanced Correlation Engine

In one embodiment, the ACE 310 includes a first input adapted to receive threat-detection results and to correlate the results to determine if there is a threat pattern. The ACE 310 also includes a second input adapted to receive security policies and to determine an appropriate response if there is a threat pattern. The ACE also includes an output adapted to provide correlation results to an event database 314. The correlation engine examines all of the reference events generated by the detection engines. This can be viewed as combining positive (behavior engine/adaption) and negative security models (signature database) with other specific aspects to web application taken into account (session, protocol). As an example consider a typical SQL Injection; at least one if not two behavioral violations will be detected (invalid characters and length range exceeded) and several signature hits will occur (SQL Injection (Single quote and equals) and SQL Injection (SELECT Statement). Any one of these events on their own will typically be a false positive, but when correlated together, they may provide a high likelyhood of an actual attack.

Another example of the correlation engine is seen when the security system is deployed in monitor only mode and an actual attack is launched against the web application. In this example, the security system will correlate the ExitControl engine events (outbound analysis) with the inbound attacks to determine that they were successful and escalate the severity of the alerting/response.

If the ACE 310 confirms a threat, then the security policy for the application, which is provided by a security policy module 312, is checked to determine the appropriate responsive action. The ACE 310 may also communicate its results to the event database 314 where the ACE results are stored. The event database 314 may also be in communication with a distributive detect prevent architecture (DDPA) module 316.

As shown in FIG. 3, the responsive action may be provided to the DDPA module 316 by the security policy module 312. The DDPA module 316 may also receive information from the ACE 310 via the event database 314. The DDPA module 316 may, for example, alert, log, or block a threat by coordinating distributed blocking with a network component, not shown, such as a firewall, Web server, or Security Information Manager (SIM).

The event database 314 may also be in communication with an event viewer 318, such as a terminal, thereby providing information about events to a network administrator. The event database 314 can also communicate input to a report generating module 320 that generates reports about the various events detected.

### Adaption Module

An adaption module 350 monitors Web traffic and continually updates and tunes a security profile module 352 that maintains security profiles of applications. The updated security profiles are communicated to the collaborative detection module 308 so that a current security profile for an application is used to determine if there is a threat to the application. Following is a more in-depth description of aspects and features of the Web application security techniques.

### Passive SSL-Decryption

It is estimated that up to fifty percent of network traffic is currently using SSL for secure communications. While necessary for secure data transit, SSL also enables hackers to embed attacks within the SSL and thereby avoid detection at the network perimeter. Through visibility into the SSL traffic an application may be afforded protection. It is preferred to provide passive SSL decryption without terminating the SSL session. The decrypted payload may be used for attack analysis only, clear text is not enabled for the internal LAN and non-repudiation is maintained for the SSL connection. An example of passive SSL decryption can be found in co-pending U.S. patent application Ser. No. 11/325,234, entitled “SYSTEM TO ENABLE DETECTING ATTACKS WITHIN ENCRYPTED TRAFFIC” filed Jan. 4, 2006, and assigned to the assignee of the present application.

As noted the adaption module 350 monitors Web traffic to develop and maintain a profile of an applications. In one embodiment, the adaption module 350 includes an input that is adapted to monitoring traffic of users as the user interacts with a Web application. The adaption module 350 also includes a profiler adapted to identify interaction between the user and the application thereby determining a profile of acceptable behavior of a user while interacting with the application. During an initialization period, the adaption module 350 develops an initial profile, then the profile is modified if additional acceptable behavior is identified. For example, as users interact with an application, or if an application is updated or modified, what is acceptable behavior may change. Thus, the adaption module 350 will modify the profile to reflect these changes. The adaption module 350 also includes an output that is adapted to communicate the profile to the security profile module 353. The adaption module 353 process creates application profiles by using an advanced statistical model of all aspects of the communication between the application and the user. This model may be initially defined during a learning period in which traffic is gathered into statistically significant samples and profiles are periodically generated using statistic algorithms. The model may be further enhanced over time and periodically updated when changes are detected in the application. This model can include validation rules for URLs, user input fields, queries, session tracking mechanisms, and components of the http protocol used by the application.

### Management Console

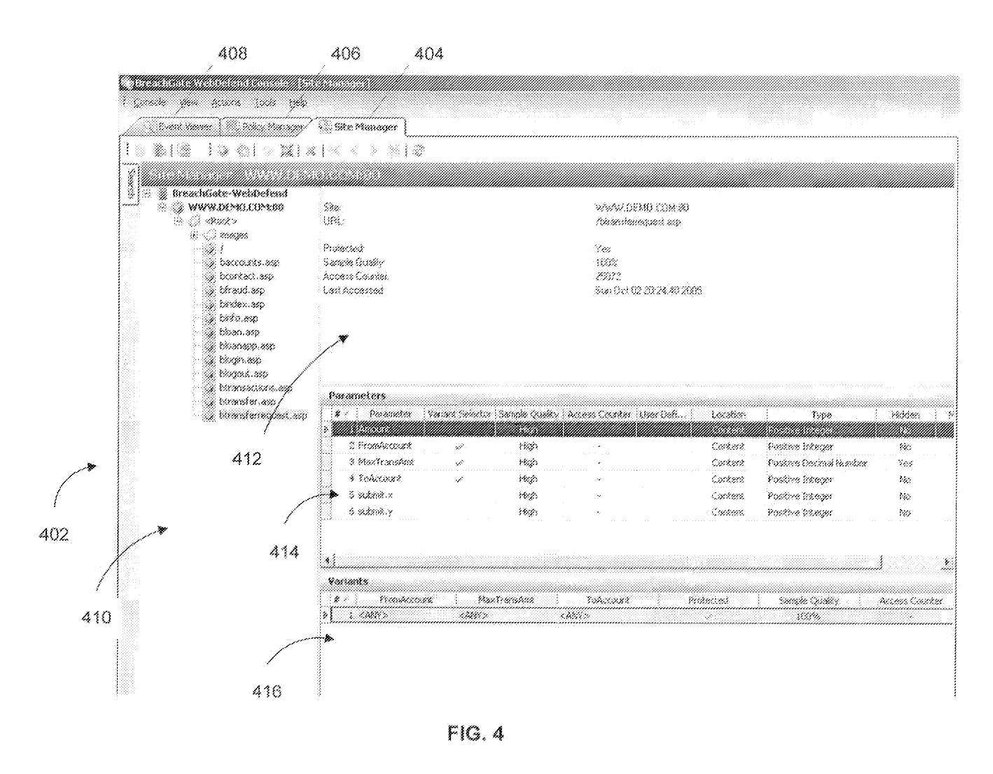

A management console can be used to generate displays of information to a network administrator on an event viewer 318 of FIG. 3. FIG. 4 is an exemplary display 402, generated by the management console, designed to enable intuitive application security management. As shown in FIG. 4, the display 402 generated by the management console can include tabs for a site manager 404, a policy manage 406, and an event viewer 408. In FIG. 4, the site manager tab 404 has been selected. The site manager display 404, generated by the management console, provides a user interface for interacting with an application's profile, as developed and stored in the adaption module 350 and application profile 352 of FIG. 3. The site manager display 404 depicts an application's security profile or model in a hierarchical tree structure. Nodes on the tree represent URL's within the application profile.

The site manager display can also include a directory window 410 allowing the network administrator to navigate through the application profile. The directory window 410 can be a site map organized in a hierarchy to provide an intuitive interface into the organizational structure of the web application.

The site manager display also includes a status window 412 where information about the status of the Web application protection system is displayed. The Status Window 412 can display the status of the attack detection engines and performance and access statistics.

There is also a parameters window 414 the status of various parameters of the Web application protection system are displayed. The parameter window 414 can list each user entry field or query in the selected URL. Each parameter entry includes the quality of the statistical sample size for this field, validation rules for determining the correct behavior of user entries in the field, and other characteristics.

The site manager display can also include a variants window 416 where information about variants that are detected can be displayed. The variant window 416 can list the response pages possible through various valid combinations of user parameters selected in the request. For example, if a page had a list of products user could select, the page would have variants for each different possible product in the list. Variants include information used to uniquely identify the response page.

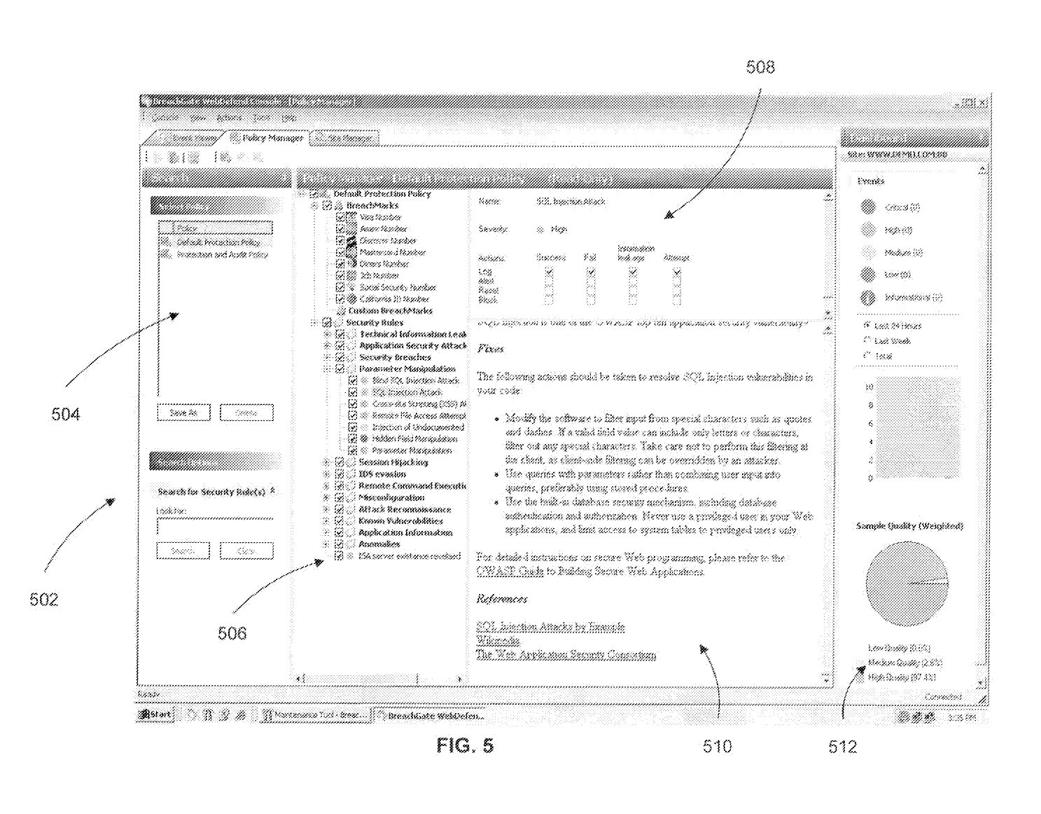

FIG. 5 is an exemplary policy manager display 502 generated by the management console. Within the Web application security system, a policy describes the configuration options for the detection engines as well as what responsive action to take when an event is detected. A policy lists the security events that the Web application security system will monitor and the responsive action to be taken if the event is detected. The policy manager display enables administrators to view and configure security policies for a Web application security system, such as the policies stored in the security policy module 312 of FIG. 3. For example, the policy manager display can provide a list of events organized into categories within a tree structure. Each event may be enabled or disabled and responsive actions for each event can be configured such as logging the event, sending a TCP Reset or firewall blocking command, or setting an SNMP trap.

Policies can be standard, out-of-the-box, policies that are configured to provide different levels of protection. Administrators can modify these standard policies in the Policy Manager to create application-specific policies. In addition, administrators can design their own policy from scratch.

The Web application security system can include special patterns, referred to as BreachMarks, that are used to detect sensitive information such as social security numbers or customer numbers in outgoing Web traffic. The BreachMarks, which can be included in the security policies, can be customized to a particular data element that is sensitive to an enterprise's business. BreachMarks allow organizations to monitor and block traffic leaving the organization which contains patterns of data known to represent privileged internal information.

The policy manager display 502 can be used to define and manage the configuration of the Web application security system mechanisms and includes the ability to fine-tune threat response on a granular level. As shown in FIG. 5, the policy manager display includes a policy window 504 where a network administrator can select a desired policy for use by the Web application security system. The policy manager display 502 also includes a navigation window 506 so that different types of security issues can be tracked and monitored. There is also a policy modification window 508 that allows an administrator to set various responses to a security attack. In the example of FIG. 5, the administrator is able to set how the Web application security system will respond to an SQL injection attack. The policy display 502 also includes a recommendation window, where suggestions for how to modify a network's operation to better prevent attacks are provided. There is also a dashboard window 512 that provides the administrator summary information about the types and severity of various events identified by the Web application security system.

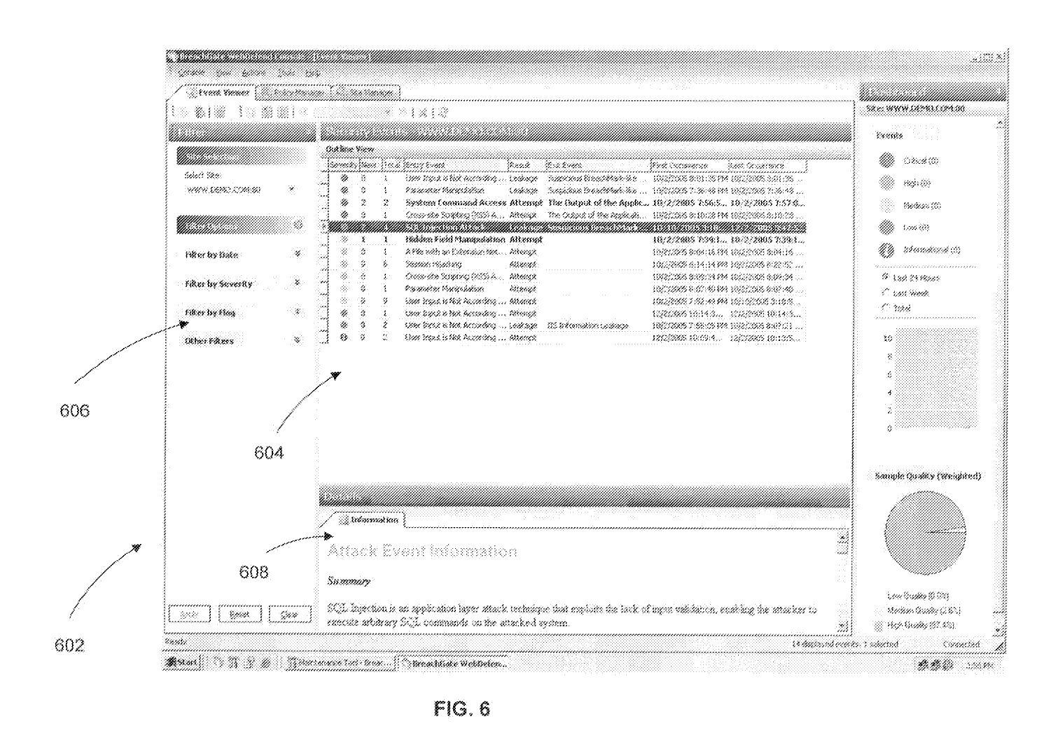

FIG. 6 is an exemplary event viewer display 602, generated by the management console, as might be displayed on the event viewer 318 of FIG. 3. Within the Web application security system, the event viewer display 602 console can include a real-time event analysis module. The event viewer display 602 includes an event detection window 604 with a list of events detected by the Web application security system. This list may include the date, the URL affected, and names both the entry event for the incoming attack as well as any exit event detected in the server's response to the attack.

In section 606, each selected event may be described in detail, including an event description, event summary, and detailed information including threat implications, fix information, and references for more research. In addition, the event viewer may provide administrators a listing of the reference events reported by the detection engines to determine this event has taken place, the actual HTTP request sent by the user and reply sent by the application, as well as a browser view of the response page. This detailed information allows administrators to understand and verify the anomaly determination made by the various detection engines.

The event viewer display 602 can also include a filter window 606 where an administrator can setup various filters for how events are displayed in the event description window 604. There is also a detail description window 606 where detailed attack information is provided to the administrator. The event filter display 602 may include filters for date and time ranges, event severity, user event classifications, source IP address, user session, and URL affected.

Returning to FIG. 3, the Web application security system can also provide a full range of reports 320 for network administrators, management, security professionals, and developers about various aspects of the security of a Web application. For example, reports can provide information about the number and types of attacks made against corporate Web applications. In addition, reports can include information with lists of attacks and techniques to assist in preventing them from occurring again. Also, application developers can be provided reports detailing security defects found in their applications with specific recommendations and instructions on how to address them.

### Collaborative Detection Module

The following discussion provides additional detail of the collaborative detection module 308 illustrated in FIG. 3. As noted in the discussion of FIG. 3, web traffic flows to the collaborative detection module 308 where the traffic is analyzed. The traffic is analyzed by a behavior analysis engine 370 in the context of appropriate application behavior compared to the applications' security profile. If an anomaly is discovered the traffic is passed to one or more of the multiple threat-detection engines included within the collaborative detection module 308. The multiple threat-detection engines work synergistically to deliver comprehensive Web application protection that spans a broad range of potentially vulnerable areas. By working together the multiple threat-detection engines are able to uncover threats by analyzing them in the context of the acceptable application behavior, known Web attack vectors and other targeted Web application reconnaissance.

Behavioral Analysis Engine

The behavioral analysis engine 370 provides positive validation of all application traffic against a profile of acceptable behavior. A security profile of acceptable application behavior is created and maintained by the adaption module 350 which monitors Web traffic and continually updates and tunes a security profile module 352 that maintains the security profiles of applications. A security profile of an application maps all levels of application behavior including HTTP protocol usage, all URL requests and corresponding responses, session management, and input validation parameters for every point of user interaction. All anomalous traffic identified by the behavioral analysis engine 370 is passed to one or more threat detection engines to identify any attacks and provide responsive actions. This ensures protection from all known and unknown attacks against Web applications.

Signature Analysis Engine

One threat detection engine in the collaborative detection module 308 can be a signature analysis engine 372. The signature analysis engine 372 provides a database of attack patterns, or signatures, for known vulnerabilities in various Web applications. These signatures identify known attacks that are launched against a Web application or any of its components. Signature analysis provides a security context for the anomalies detected by the behavioral analysis engine 370. When attacks are identified they are ranked by severity and can be responded to with preventative actions. This aspect of the Web application security system provides protection from known attacks against Web applications, Web servers, application Servers, middleware components and scripts, and the like.

Protocol Violation Engine

The collaborative detection module 308 can include a threat detection engine referred to as a protocol violation engine 374. The protocol violation engine 374 protects against attacks that exploit the HTTP and HTTPS protocols to attack Web applications. Web traffic is analyzed by the behavioral analysis engine 370 to ensure that all communication with the application is in compliance with the HTTP and HTTPS protocol definitions as defined by the IETF RFCs. If the behavioral analysis engine 370 determines that there is an anomaly, then the traffic is analyzed by the protocol violation engine 374 to determine the type and severity of the protocol violation. The protocol violation engine 374 provides protection against attacks using the HTTP protocol, for example, denial of service and automated worms. Session Manipulation Engine

Session Manipulation Analysis Engine

Another threat-detection engine that can be included in the collaborative detection module 308 is a session manipulation analysis engine 376. Session manipulation attacks are often difficult to detect and can be very dangerous because cybercriminals, such as hackers, impersonate legitimate users and access functionality and privacy data only intended for a legitimate user. By maintaining all current user session information, it is possible to detect any attacks manipulating or hijacking user sessions, including session hijacking, hidden field manipulations, cookie hijacking, cookie poisoning and cookie tampering. For example, a state tree of all user connections may be maintained, and if a connection associated with one of the currently tracked sessions jumps to another users session object, a session manipulation event may be triggered.
a. Cookies

Cookies are the applications way to save state data between 2 separate Http request/replies. The server sends a set-cookie header in its reply & the client send back a cookie header in the following requests. It is expected that the cookie header will appear in the request with a value that is equal to the value of the matching set-cookie header that appeared in the previous server reply. When receiving a server reply, the parser will find all the “set-cookies” headers in it. These will then be stored in the session storage by the system. When receiving the following request, the parser will find all the “Cookie” headers in it. During the system validation of the request, the cookie headers received will be compared to the “set-cookie” in the session storage.

The system validation will be separated into minimal validation and regular validation. The minimal validation occurs when a cookie has a low Sample Quality (the process of learning the cookies has not completed yet). During this time, the cookie will simply be compared to the set-cookie and an event will be triggered if they do not match. In addition, the fact that the two matched or not will be learnt as part of the system collection/adaption process. After enough appearances of the cookie, the generation will turn the cookies' certainty level to high and mark if the cookie needs to be validated or not. Once the cookie's Sample Quality turns to high, it will be validated only if it was learned that the cookie value matches the set-cookie that appeared before.
b. Hidden Fields

In certain Url (source Url) the HTML form tag <form> can appear with specific action that points to other Url (target Url) <form action=“target_url”>. Target Url can be reached for example when pressing the “submit” button from the source Url. On the source Url as part of the <form> various HTML controls (input fields) can appear. These input fields have attributes that describe their type and value. This data will be sent to the target Url in the form of parameters clicking the submit button, i.e. the fields of the source Url are parameters of the target Url.

Some fields of the Url are displayed by the browser for the user to fill with data; then when pressing the submit button, a request for the target Url is generated, while passing these fields as parameters. Examples for such fields are: name, age, date. Other fields may be of type “hidden” and have a value set for them by the server when the reply page is sent; this means that these fields are not displayed by the browser and the user does not see them. However, these fields are also sent as parameters to the target Url. The value sent together with the hidden parameters is expected to be the same value which the server sent in the reply of the source Url. Examples for such fields can be: product-id, product-price.

Another type of input fields that can be mentioned is “password”. These fields are displayed to the user, which fills them with data. Browsers do not show the value of password type parameters when it is entered and show “***” instead. It is expected that parameters that are of type password will also have another attribute in the source Url reply: auto-complete=off (meaning, the browser cannot use the auto complete feature and save previous values entered to the field).

In some cases, client side scripts, such as java scripts, can modify the value of the hidden field. In these cases, even though a field is marked as hidden its value does not match the expected one. When receiving a reply, the system searches for target Url forms with hidden fields. It will save data on the hidden fields of each Url and their expected values in the session storage. During the Adaption, once the target Url is accessed, the ALS will check if the value of the hidden fields matches one of the expected values stored earlier. While generating a policy for a parameter, the system will check if the field was learned as a hidden field enough times and decide if this field is to be validated as a hidden field or as a regular parameter. During the validation, values of parameters that are validated as hidden fields will be compared to the values that were retrieved earlier and were stored in the session storage.

As part of this processing, recognizing fields as password types is also supported. The fields will be recognized as password type during the parsing of the. If a field was learned as type password enough times it will be marked as such. Fields of type password will be generated as bound type parameters with their lengths and char groups. The system is alerting when a field in the target Url is marked as password type, but the auto-complete flag for it is not turned off.
c. Passive Session Tracking

A predefined list of regular expressions that can identify session IDs in requests and replies is defined. A generation process will choose a subset of these session ID definitions as the ones that are used to identify sessions. These session IDs will be searched for in all requests and replies. The session IDs will be extracted from the request using a combination of the request's objects (such as cookies, parameters, etc), and general regular expressions that are used to extract specific session data. Each set of regular expressions defines which part of the request it runs on, and can be used to extract a value and optionally extract up to two names. In addition, if the regular expression is being searched for in the URL, it can also extract the indexes of an expression that needs to be removed from it. Regular Expression Sets can have one of the following types:
1. Param: Includes two regular expressions. One is searched for in the parameter name, and the other in its value.
2. WholeCookie: Includes two regular expressions. One is searched for in the cookie name, and the other in its value (the entire cookie value, without additional parsing).
3. CookieParam: Includes three regular expressions, and works on cookies that have been separated correctly into names and values. The first expression is on the cookie's name, the second—on the cookie's parameter name, and the third on the cookie parameter's value. For example, in the cookie header: “Cookie: mydata=lang=heb|sessionid=900” the cookie's name is “mydata”, the two parameters are “lang” (with the value “heb”) and “sessionid” (with the value 900).
4. SemiQuery: Includes one regular expression that is run on the query that comes after a semicolon. For example, in the URL “/a.asp;$isessionid$123”, the regular expression will run on the underlined part.
5. NormURL: This regular expression runs on the normalized URL. It may return indexes, in which case the part of the URL that is between these indexes is removed. This is done to support sessions that are sent as part of the URL but should not be included in the URL when it is learnt by the ALS.
6. Header: Includes two regular expressions. One is searched for in the header name, and the other in its value.

Table 1 list some exemplary definitions of a few regular expression sets that can be used inside the security system.

TABLE 1
Sample Definitions of Expression Sets used in the security system

| Index* | Type | Regular Expressions | Parenthesis | Description |
|---|---|---|---|---|
| 1 | Param | Param Name: | 1 - Name | Detects the |
| | | (jsessionid) | 2 - Value | jsessionid |
| | | Param Value: (.*) | | parameter. |
| 2 | SemiQuery | \$(jsessionid)\$(.*) | 1 - Name | Detects a less |
| | | | 2 - Value | popular variant |
| | | | | of jsessionid in |
| | | | | the semi-query. |
| 3 | CookieParam | Cookie Name: (.*) | 1 - Name₁ | Detects cookies |
| | | Cookie Param Name: | 2 - Name₂ | that have parameters |
| | | (.*session₋ id.*) | 3 - Value | that contain the |
| | | Cookie Param Value: | | string session₋id |
| | | (.*) | | in their name. |
| 4 | NormURL | \/(\(([\hat{ })/]*)\)\/) | 1 - Index | Detects URLs |
| | | | 2 - Value | with a bracketed |
| | | | | session ID (such as |
| | | | | /abc/(123)/a.asp) |

*The index is a numeric identifier of the regular expression set.

Usage Analysis Engine

Still another threat detection engine that can be included in the collaborative detection module 308 is a usage analysis engine 378. The usage analysis engine 378 provides analysis of groups of events looking for patterns that may indicate that a site is being examined by a potential attacker. Targeted Web application attacks often require cybercriminals to research a site looking for vulnerabilities to exploit. The usage analysis engine 378, over time and user sessions, can provide protection against a targeted attack by uncovering that a site is being researched, before the site is attacked. The usage analysis engine 378 correlates event over a user session to determine if a dangerous pattern of usage is taking place. An example of this analysis is detecting a number of low severity events resulting from a malicious user probing user entry fields with special characters and keywords to see how the application responds. These events may not raise any alarms on their own but when seen together may reveal a pattern of usage that is malicious. Another example of this analysis is detecting brute force login attempts by correlating failed login attempts and determining that threshold has been reached and thus, the user may be maliciously trying to guess passwords or launching a dictionary attack of password guesses at the web application. Another example of this analysis is detecting scans by security tools when an abnormal amount of requests are received in the same session. Yet another example of this analysis is detecting http flood denial of service attacks when an abnormal number of duplicate requests are received in the same session. This analysis can be easily extended to detect distributed denial of service attacks by boot networks correlating multiple individual denial of service attacks.

Exit Control Engine

Yet another threat detection engine that can be included in the collaborative detection module 308 is an exit control engine 380. The exit control engine 380 provides outbound-analysis of an application's communications. While all incoming traffic is checked for attacks, all outgoing traffic is analyzed as well. This outgoing analysis provides essential insight into any sensitive information leaving an organization, for example, any identity theft, information leakage, success of any incoming attacks, as well as possible Web site defacements when an application's responses do not match what is expected from the profile. For example, outgoing traffic may be checked to determine if it includes data with patterns that match sensitive data, such as a nine digit number, like a social security number, or data that matches a pattern for credit numbers, drivers license numbers, birth dates, etc. In another example, an application's response to a request can be checked to determine whether or not it matches the profile's variant characteristics.

Web Services Analysis Engine

Another threat detection engine that can be included in the collaborative detection module 308 is a Web services analysis engine 382. The Web services analysis engine 382 provides protection for Web Services that may be vulnerable to many of the same type of attacks as other Web applications. The Web services analysis engine 382 provides protection from attacks against Web services such as XML viruses, parameter tampering, data theft and denial of Web services attacks.

Threats detected by any of the above threat detection engines in the collaborative detection module 308 are communicated to the advanced correlation engine 310 where they are analyzed in context of other events. This analysis helps to reduce false positives, prioritize successful attacks, and provide indications of security defects detected in the application. In one embodiment, the advanced correlation engine 310 can be based upon a positive security model, where a user's behavior is compared with what is acceptable. In another embodiment, the advanced correlation engine 310 can be based upon a negative security model, where a user's behavior is compared to what is unacceptable. In yet another embodiment, the advanced correlation engine 310 can be based upon both models. For example, the user's behavior can be compared with what is acceptable behavior, a positive model, and if the behavior does not match known acceptable behavior, then the user's behavior is compared with what is known to be unacceptable behavior, a negative model.

The results from the collaborative detection module 308 are communicated to the advanced correlation engine (ACE) 310 for further analysis of events. Examples of some types of analysis performed by the ACE 310 can include the following.

Application Change Detection

One type of analysis that can be performed by the advanced correlation engine 310 is an analysis to determine if there is a change in the number of events produced for a page. One technique for recognizing a change in a Page (URL) is based on the number of events produced for the URL as well as on the event rate. Unlike a ‘Simple Change Detection feature’ where the change is detected when event rate has changed, the Application Change Detection takes into consideration the ratio between total number of events for a specific URL and number of requests.

In one embodiment, a system assumes that application browsing profile, that is the amount of resource hits, might change during the day and week. As a result, the number of events, including false-positives, produced during the day or week might change. When detecting a change, the system assumes one of the following scenarios, and supports both:
a. The nature of the application was not changed, meaning that the application is expected to be browsed at the same rate and profile like it was before the change.
b. The browsing profile has changed, which includes the peak time.

When the system starts its operation, no Change Detection is searched for. Once an Initial Adaption period is completed, each URL learnt initiates its “adjustment period”, where it calculates the allowed event rate for each URL per time slot. The event rate limit for each URL is generated at the end of the “adjustment period.” The “adjustment period” can be defined, for example, by the number of successful generations performed. In one embodiment, any URL that arrives after the Initial Period is over will immediately enter its “adjustment period.” In other embodiments, a URL that arrives after the Initial Period is over will enter its “adjustment period” at a desired time.

When a change is detected an event should be triggered. Only events with status codes that are not error status codes contribute to the calculating event rate, otherwise the request is likely to be an attack, not an application change. Typically, events can be partitioned into the following groups:
a. Event on unexpected URL—Once most of the application resources were browsed the number of these events is expected to be significantly low. Incremental change in the number of this event should indicate that additional resources, such as files, were added to the application. It is noted that typically, this type of event can be only be monitored on the Application Level.
b. Events on unexpected resources (Parameter, Variant)—Once most of the application resources were browsed the number of such events is expected to be significantly low. Incremental change in the number of such events should indicate that additional resources were added to the application.
c. Events on entry policy violation—These events might result from bad policy, attack, or application change. In this case, an application change refers to changing values of parameters, their number of appearance, or their location within the request.
d. Events on exit policy violation—These events might result from bad policy, application change, or attack. Application change refers to replacing a static content with another (hash fingerprint), or changing the reply structure (in case of dynamic content, identified by other fingerprints). An attack is less common in this case. Attacks that result with patterns violation should rarely happen, while attacks that successfully replaced a page with another can be identified as a valid change (unless a fine-grained correlation is supported).
e. System Limitation (Parser) or Application Limitation (HTTP Constraints) events—These events don't result from application change, therefore are not used for the calculation.
f. Any Header Related Event (Unexpected Header, Invalid Header Length)—It is assumed that any violation of headers policy or any new header learnt have nothing to do with any application change. Besides, when a user takes action to clear the Application or URL he does not expect the Headers policy to be cleared as well.

Calculating Allowed Event Rate

A technique that can be used to establish whether a Page (URL) was changed, is to calculate the allowed event rate for the URL first. The calculation can be based on event rate per time slot relatively to the number of request per time slot. When calculating the allowed event rate per time slot:
a. Only events from the above groups' c and d will be taken into account.
b. If an event on “security signatures” appears in request or reply we will consider the request to be likely an attack and therefore we will not take any events of this request into consideration for calculating allowed event rate. If an event on “non security” signature appears in request or reply we will count the request, but not the event. This assumes that the events of Signatures are divided into “Security” and “Non security” events.
c. Total number of requests per time slot should not include the requests that returned error status codes.

The system is sampling the number of times events (mentioned above) are submitted in order to produce a limit which indicates the expected maximum number of events per time slot, for each URL. Calculating allowed event rate for URL is an ongoing process that continues also after the limit was set for the first time in order to update itself according to the current event rate. The calculation stops if URL/Application change was detected (Detecting Change) and is not restarted until specific reset (User Scenarios)

Generating Allowed Event Rate

Because the security system implements a continuous learning, profiles are expected to be generated along the operation. Since the number of profiles is dynamic and constantly increasing, so does the number of expected false-positive events. In addition, user is expected to fix profiles to reduce the number of false-positives. System should take this assumption into account when generating allowed event rate. The calculation should take into account the number of profiles existed during the sampling. This can be done by normalizing the number of events with the Sample Quality of a URL.

Detecting Change

The system should recognize an application change at both the URL level and Application Level. Once the allowed event rate for URL is generated, the system enters period where it tries to detect any URL change by comparing the calculated event rate to the maximum allowed rate.

1. Change Detection at URL Level
a. A change should be identified at URL once the event submission rate calculated per time slot for specific URL has changed (increased).
b. Automatic URL relearning is achieved by a directive in configuration file. Once this directive is on and a change was detected at URL level the URL should be deleted (the learning should restart).

2. Change Detection at Application Level
a. To establish application change we need to monitor the changes of URLs that belong to the application and new URLs that were added to the application.
b. A change should be identified once CD_CHANGED_URLS% of URLs were changed or CD_NEW_URLS% URLs were added in last CD_NUM_SLOTS_NEW_URLS slots or both.
a URL is considered new URL, only if it was added to the database, if an event was triggered for ‘Unexpected URL’ but it was not added to the database due HTTP Constraints Violation this URL will not contribute to the total count of new URLs.

A disadvantage of it is that some new long URL can be added to the application and we will not detect the change. On the other hand if we allow such URLs to be counted, we can face situation that Application will show that new URLs were added but actually no such URLs will be in the system.

Aspects of Correlating ALS Signatures

Another type of analysis that can be performed by the advanced correlation engine 310 is an analyze events generated by the behavioral system (Adaption), along with the events generated by signatures, are then passed into the correlation system. The signatures events are used to strengthen the severity of the detected anomaly and evaluate their importance and correctness (and vice-versa).

Correlating Attack and Result Events

The Correlation module generates two classes of Correlated Event (CE): Attack CE and Result CE. An attack CE is a CE that has been generated by the Request part of the HTTP connection. A result CE is a CE that has been generated by the Reply part of the HTTP connection. Each result CE is part of one result category out of five categories: Success, Fail, Attempt, Leakage and Informative. Events shown to the user can be 1) Attack CE 2) Result CE and 3) couples of two CE: one Attack CE and one Result CE. Table 2below provides an example of how the Matrix is built.

TABLE 2
Exemplary Attack/Results Matrix

| | Result Category | | | | | | |
|---|---|---|---|---|---|---|---|
| | Success | | Failed | | Leakage | | |
| | Result CE Type | | | | | | |
| | | | Unsuccessful | | Leakage of | | |
| | | | Attack with | | database | | At- |
| Attack CE | Potentially | | Status Code | | table | | tempt |
| Type | successful | . . . | 404 | . . . | information | . . . | N/A |
| SQL | | 1. | 2. | 3. | 4. | 5. | 6. |
| Injection | | | | | | | |
| System | 7. | 8. | 9. | 10. | 11. | 12. | 13. |
| command | | | | | | | |
| injection | | | | | | | |
| attack | | | | | | | |
| Cross site | 14. | 15. | 16. | 17. | 18. | 19. | 20. |
| scripting | | | | | | | |
| (XSS) | | | | | | | |
| attack | | | | | | | |
| Remote | 21. | 22. | 23. | 24. | 25. | 26. | 27. |
| File | | | | | | | |
| access | | | | | | | |
| . . . | 28. | 29. | 30. | 31. | 32. | 33. | 34. |

Following the Correlation processing, it might be that not all Attacks/Results events falls into the above table. In this case, the following scenarios are also valid:
a. One Attack CE and Zero Result CE—In this case, the result CE category will be an Attempt but no concatenation will be done in the various description fields.
b. Zero Attack CE and One Result CE—The ‘Event’ column will show the result name (usually, it shows the Attack CE name) and description will only contain Result CE descriptions. The result category will be defined by the Result CE Type.
c. Two Attack CEs and One Result CE—Two couples will be shown to the user: (Attack1, Result) and (Attack2, Result)
d. One Attack CE and Two Result CEs—Only one attack couple will be shown to the user. The Result CE with the higher severity will be chosen. If both Result CEs have the same severity values, then one Result CE will be picked randomly. The second result will be handled as described in section 2.3.6.2.
e. Two Attack CEs and Two Result CEs—In this case, two couples will be shown with two different attacks. The result CE with the higher severity will be chosen for the Attack CE with higher severity. Symmetrically, the Attack lower Severity will be associated with the Result CE with lower severity. If both Result CEs have the same severity values, then each Attack CE will be assigned randomly a different Result CE.
f. X Attack CEs and Y Result CEs—The Attack and Result CEs will be sorted according to their severity values and the first Attack CE will be associated with the first Result CE, the second Attack CE with the second Result CE.

Variants

Properties of a request+reply, as can be used by the exit control engine 378, are not learned for each URL but for subsets of the requests for each URL. The URL may be divided into several variants, and properties of the reply learned for each variant. Each variant is defined by the URL and the parameters and values of this URL. Learning the properties of a certain URL's reply consists of the following general stages:
a. Collect data about the requests and replies.
b. Go over all parameters of the URL. For each parameter decide whether it has a limited (small) number of options. If so, keep the options and give them ID numbers. Otherwise do not keep the options. This is actually done on the fly, during the data collection.
c. Go over all requests+replies, and calculate which URL variant each one belongs to. This is done using a vector that depends on the parameters and their values. The order of the parameters in this vector is the same, even if different requests arrive with a different order of parameters.
d. The fingerprint and BreachMarks are learned for replies that use the same URL Variant.
e. When validating a reply, its URL variant is calculated and its properties (size, title, etc) are matched with the properties learned from the other requests to the same URL variant.

For example, assume the URL /catshop.cgi can receive the following parameters:

“product”: can be one of the following strings: “catnip”, “lasagna”, “wool”, “mouse”.

“credit_card”: can be any credit-card number.

“quantity”: can be “1”, “2” or “3”.

The URL variant of the request “/catshop.cgi?product=mouse&credit_card=1234567890” would be “/catshop.cgi?product=mouse&credit_card=<ANY>”. Note, that because credit_card has not been learned as a list, it gets the value <ANY>. Also note, that the ‘quantity’ parameter did not appear in the URL variant.

In another embodiment, the properties of a request+reply, used by exit control engine, are not learned for each URL but for subsets of the requests for each URL. The URL is divided to resources, and properties of the reply are learned for each resource. Each resource is defined by a key, which consists of a URL and the parameters and values of this URL. The process includes the following steps:
a. Collect data about the requests and replies.
b. Go over all parameters of the URL. For each parameter decide whether it has a limited (small) number of options. If so, keep the options and give them ID numbers. Otherwise do not keep the options. This is actually done on the fly, during the data collection.
c. Go over all requests+replies, and calculate the key of each one. The key is a vector that depends on the parameters and their values. The order of the parameters in the key is the same, even if different requests arrive with a different order. The key calculation is done as follows, for each parameter of the URL:
d. If it does not appear, write 0.
e. If it appears but the parameter has a large number of options, write 1.
f. If it appears and has a defined range of options, write the ID of the option that arrived.
g. Group together the parameters that have the same key (i.e. same url, same parameters and same parameters' values). For each group, learn the following properties of the reply:
   Size.
   Title.
   Patterns (mandatory, forbidden and special).
   Number of images.
   Number of links.
   Number of forms.
   Hash
   Content type

When validating a reply, its key is calculated and its properties (size, title, etc) are matched with the properties learned from the other requests with the same key. For example, assume the URL /catshop.cgi can receive the following parameters:

“product”: can be one of the following strings: “catnip”, “lasagna”, “wool”, “mouse”.

“credit_card”: can be any credit-card number.

“quantity”: can be “1”, “2” or “3”.

“notify”: can appear several times, with the following strings: “email”, “snailmail”, “sms”, “singing_clown”.

In stage 2, the parameters are analyzed:

“product”: Each string gets and ID: “catnip”=1, “lasagna”=2, “wool”=3, “mouse”=4.

“credit_card”: Recognized as a parameter with many changing values.

“quantity”: Each value gets and ID: “1”=1, “2”=2, “3”=3.

“notify”:

Because the parameter can appear several times, there are actually 24 options. If many combinations really appear, there are too many options and the parameter will be recognized as one with many changing values. If only a small subset of the options actually appears, they are listed and given ids. For example, the combination “email”, “snailmail” gets the ID 1, and the combination “snailmail”, “singing_clown” gets the ID 2.

In stage 3, keys are calculated for all requests. The keys are vectors that contain a value for each parameter, in the same order as above. For example the request “/catshop.cgi?product=mouse&credit_card=1234567890&quantity=2” gets the key: 4, 1, 2, 0. And, the request “/catshop.cgi?product=catnip&notify=snailmail&notify=singing_clown” gets the key: 1, 0, 0, 2. In stage 4, all possible keys have been detected. For each one, the data about the replies is learned.

Learning Parameter Values

There are several techniques for learning a list of values for a given parameter. For example, parameter values may be learned on the fly during the learning period, in order to avoid saving the values of all requests to the database when there are many such values. The output of the process may be used both for exit control and for entry control.

In one example, a table with a desired number of rows and columns may be kept for every parameter. In this example, the table has 30 rows and three columns, the columns are labeled value, appearances and initial. The value column keeps strings (the value of a parameter), the appearances column keeps the number of appearances of this value, and the initial column keeps the date when the value first arrived. The table may initialized with empty rows (appearances=0).

Whenever a value arrives for the parameter, it is searched for in the table. If it is already there, the “appearances” column of its row is incremented by 1. When a value that is not in the table arrives, it is added to the table, replacing the value with the lowest number of appearances (if several values have the same number of appearances, the value that is replaced is the one with the lowest “initial” value). Note that in this example the list has been initialized with 30 values, so there is always a row to replace.

A special case exists with values that are longer than 40 characters. Such values are unlikely to be parts of static lists, so it is not necessary to waste memory on saving them. These values are dropped and not inserted to the table. When they arrive, only the total number of requests for the parameter is increased.

When the learning period is over, the resulting table may be used both for exit and for entry control. The final table can include the same columns as before, and may also include additional columns. In this example, an additional column “probability”, has been added which defines the percent of times out of the total number of requests that the value appeared. The probability is calculated by dividing the “appearances” column by the total number of requests (“n_reqs”).

Entry Control

In this part of the learning, it is decided whether a parameter can be validated as a list. A “Property ref” is calculated for all the values of the parameter in the table, as it was calculated in the Learning Ranges section. Next, all the values in the table care checked. Values that have a percent that is smaller than the value of property ref are removed from the table. Now, the percent of appearances of values that are not in the table is calculated (1 minus the sum of the percents of all values in the table). If this percent is higher than ref, the parameter isn't learned as a list. Otherwise, the resulting table is kept and used for request validation. Values that do not appear in the table trigger an alert.

Exit Control

Even if the table was learned as a list, it might still be useful to divide replies to URL variants according to the different values of this list. This can happen when the list is very long, for example, more than a length of 30. One technique that can be used to verify that a list can be used for exit-control, is to sum the “probability” values of the 10 values with the highest probability. If the sum is more than 0.8 (80% of the requests used one of these 10 values), then the corresponding rows are selected as the list of values for the parameter. In this case, if more than 10 values appear, the rest of the values are combined as one option (“other”). If the sum of the probabilities was lower than 0.8, the algorithm decides that the parameter can accept many changing values and the list is not used for exit-control.

### Distributed Detect Prevent Architecture Module (DDPA)

The Web application security system can also include a distributed detect prevent architecture module (DDPA) 316 for distributed threat management. The DDPA module 318 can allow organizations to manage application security in the same way they presently manage the applications themselves. Because the Web application protection module 128, shown in FIG. 1, is not in-line, it does not interfere with production network traffic to protect the application or to institute alerting or blocking actions. Thus, the DDPA 316 allows organizations to choose a blocking point, and which best-of-breed network-level device to intercept potential threats. For example, the DDPA 316 can use firewall blocking, TCP resets to the Web server, and SNMP to alert a network monitoring device.

As an out-of-line appliance, the Web application protection module 128 is architected to allow for detection of threats within the context of the application, unlike devices designed to be in-line that focus on the network packet level. The Web application protection module 128 can detect potential threats and then work with the appropriate network-level device, such as a firewall to block malicious behavior. Because of its flexibility and ease of management, the Web application protection module 128 provides centralized application monitoring with distributed threat protection.

The Web application protection module 128 provides protection of many threats, including, but not limited to the following list:
SQL Injection
Cross-site Scripting
Known and Unknown Application-Level attacks
Zero Day Attacks
Session Hijacking
Cookie Tampering
Protocol Manipulation
Automated Worms
Attack Reconnaissance
Data Leakage & Identity Theft
XML Parameter Tampering Data Theft
OWASP Top 10 Security Threats

### EXEMPLARY EMBODIMENTS

To illustrate how aspects of the Web application protection system operates, following are description an exemplary prevention of an SQL injection and a Session Hijacking, two of the most common and dangerous Web application targeted attacks.

Preventing a SQL Injection Attack

An SQL Injection is an attack method used to extract information from databases connected to Web applications. The SQL Injection technique exploits a common coding technique of gathering input from a user and using that information in a SQL query to a database. Examples of using this technique include validating a user's login information, looking up account information based on an account number, and manipulating checkout procedures in shopping cart applications. In each of these instances the Web application takes user input, such as login and password or account ID, and uses it to build a SQL query to the database to extract information.

With user credential validation or account lookup operations, one row of data is expected back from the database by the Web application. The application may behave in an unexpected manner if more than one row is returned from the database since this is not how the application was designed to operate. A challenge for a cybercriminal, or hacker, wanting to inappropriately access the database, is to get the Web application to behave in an unexpected manner and therefore divulge unintended database contents. SQL Injections are an excellent method of accomplishing this.

SQL queries are a mixture of data and commands with special characters between the commands. SQL Injection attacks take advantage of this combination of data and commands to fool an application into accepting a string from the user that includes data and commands. Unfortunately, a majority of application developers simply assume that a user's input will contain only data as query input. However, this assumption can be exploited by manipulating the query input, such as by supplying dummy data followed by a delineator and custom malicious commands. This type of input may be interpreted by the Web application as a SQL query and the embedded commands may be executed against the database. The injected commands often direct the database to expose private or confidential information. For example, the injected commands may direct the database to show all the records in a table, where the table often contains credit card numbers or account information.

A technique to protect Web applications from SQL Injection attacks is to perform validation on all user input to the application. For example, each input field or query parameter within the application may be identified, typed and specified in the security profile during the Adaption process. While validating traffic against an application's security profile, all user input can be checked to ensure that it is the correct data type, it is the appropriate data length, and it does not include any special characters or SQL commands. This technique prevents SQL Injection attacks against a Web application by ensuring that user input is only data with no attempts to circumvent an application's normal behavior.

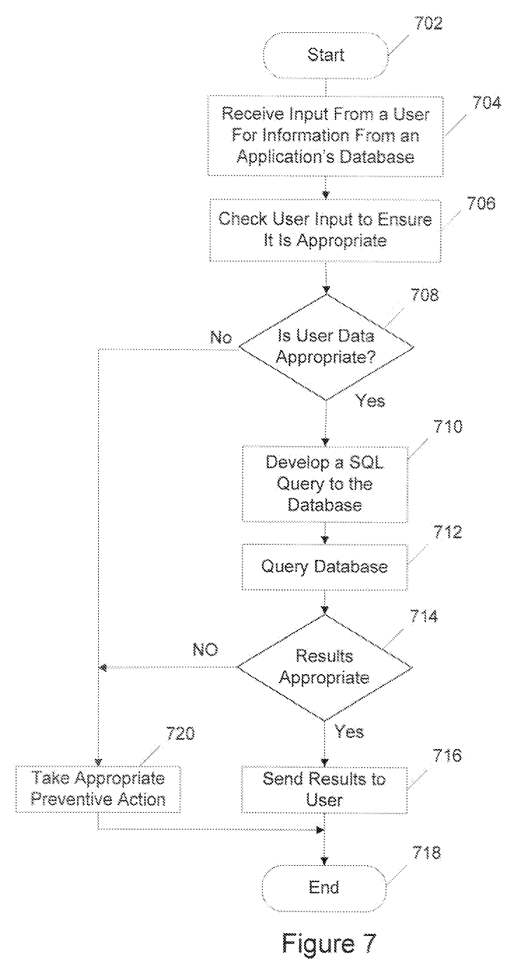

FIG. 7 is a flow chart illustrating an exemplary technique for preventing a SQL Injection attack. Flow begins in block 702. Flow continues to block 704 where input from a user requesting information from an application's database is received. An example of a user requesting information from a database include a shopper requesting the price or availability of an items at a shopping web site. Flow continues to block 706 where the user input is checked to ensure that it is an appropriate. For example, each input field is checked to ensure that it is the correct data type, it is the appropriate data length, and it does not include any special characters or SQL commands.

Flow continues to block 708 where it is determined if the user data is appropriate. If the user data is appropriate, a positive outcome, then flow continues to block 710. In block 710 a SQL query to the database using the user input is developed. Flow continues to block 712 where the data base is queried. Then in block 714 it is determined if the results returned from the query are appropriate. If the results are appropriate, a positive outcome, then flow continues to block 716 and the query results are sent to the user. Flow continues to block 718 and ends.

Returning to block 714, if the query results are not appropriate, a negative outcome, then flow continues to block 720. Now, returning to block 708, if it is determined that the user data in not appropriate, a negative outcome, flow continues to block 720. In block 720 appropriate preventive action is taken to protect the integrity of the application. For example, the user request can be blocked, or the query results blocked from being sent to the user. A notification can also be logged to indicate that the user attempted to inappropriately access the database, of that what appeared to be a valid user input returned unexpected results from the data base. The notifications can be used to alert a network administrator about questionable behavior by a user. The notifications can also be used in the adaption of the applications profile, as well as updating threat detection engines. For example, a signature analysis engine may be updated to reflect a new attack pattern that the application is vulnerable to. After the appropriate preventive action has been taken, flow continues to block 718 and ends.

Preventing Session Hijacking

Session Hijacking is a method of attacking Web applications where a cybercriminal, or hacker, tries to impersonate a valid user to access private information or functionality. The HTTP communication protocol was not designed to provide support for session management functionality with a browser client. Session management is used to track users and their state within Web communications. Web applications must implement their own method of tracking a user's session within the application from one request to the next. The most common method of managing user sessions is to implement session identifiers that can be passed back and forth between the client and the application to identify a user.

While session identifiers solve the problem of session management, if they are not implemented correctly an application will be vulnerable to session hijacking attacks. Hackers will first identify how session identifiers have been implemented within an application and then study them looking for a pattern to define how the session identifiers are assigned. If a pattern can be discerned for predicting session identifiers, the hacker will simply modify session identifiers and impersonate another user.

As an example of this type of attack consider the following scenario. A hacker browses to the Acme Web application which is an online store and notices that the application sets a cookie when accessing the site and the cookie has a session identifier stored in it. The hacker repeatedly logs into the site as new users, getting new session identifiers until they notice that the ID's are integers and are being assigned sequentially. The hacker logs into the site again and when the cookie is received from the Acme site, they modify the session identifier by decreasing the number by one and clicking on the account button on the site. The hacker receives the reply from the application and notices that they are now logged in as someone else, and have access to all of that person's personal information, including credit card numbers and home address.

To protect against session hijacking attacks, all user sessions may be independently tracked as they are assigned and used. The Adaption process, as performed in block 350 of FIG. 3, can automatically identify methods of implementing session management in Web applications. It is then possible to detect when any user changes to another user's session and can immediately block further communication with the malicious user. For example, once the Session identifiers are learned, the session engine can maintain a state tree of all user sessions correlating the web application session identifiers with tcp/ip session identifiers and can identify when a session attempts to hijack another.

This application incorporates herein by reference, in their entirety, U.S. Provisional Application Ser. No. ______, entitled “System and Method of Preventing Web Applications Threats” and U.S. Provisional Application Ser. No. ______, entitled “System and Method of Securing Web Applications Across an Enterprise” both of which are filed concurrently with the present application.

Those of skill in the art will appreciate that the various modules and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules and method steps described in connection with the embodiments disclosed herein can be implemented or performed with a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

1. A method of securing a Web application, the method comprising:
receiving Web traffic;
verifying the traffic against a profile of acceptable behavior for a user of the application and identifying anomalous user traffic;
analyzing the anomalous traffic by at least one threat-detection engine; and
correlating and results from the at least one threat-detection engine to determine if there is a threat to the Web application.

2. The method as defined in claim 1, wherein the at least one threat-detection engine comprises a signature analysis engine.

3. The method as defined in claim 1, wherein the at least one threat-detection engine comprises a protocol violation engine.

4. The method as defined in claim 1, wherein the at least one threat-detection engine comprises a session manipulation engine.

5. The method as defined in claim 1, wherein the at least one threat-detection engine comprises a usage analysis engine.

6. The method as defined in claim 1, wherein the at least one threat-detection engine comprises an exit control engine.

7. The method as defined in claim 1, wherein the at least one threat-detection engine comprises a web services analysis engine.

8. The method as defined in claim 1, wherein verifying the traffic comprises analyzing the traffic with a behavior analysis engine.

9. The method as defined in claim 1, wherein the profile of acceptable behavior is automatically developed.

10. The method as defined in claim 1, wherein the profile of acceptable behavior is automatically updated as users interact with the application.

11. A method of profiling acceptable behavior of a user of a Web application, the method comprising:
monitoring traffic of the use as the user interacts with the Web application;
identifying interaction between the user and the application thereby determining a profile of acceptable behavior of a user while interacting with the application; and
continuing monitoring of traffic of users and modifying the profile if additional acceptable behavior is identified.

12. The method as defined in claim 11, further comprising using the profile in a collaborative detection engine to identify anomalous user behavior.

13. The method as defined in claim 11, wherein the profile of acceptable behavior is determined during an initialization period.

14. A Web application security system comprising:
a correlation detection module adapted to analyze Web traffic against a profile of acceptable user behavior for interacting with the Web applications and to identify and analyze anomalous user behavior and to output results of the analysis;
an adaption module adapted to monitor user behavior and modify the profile during the life of the application; and
a correlation engine adapted to analyze the outputs of the collaborative detection module to determine if there is a threat.

15. The security system as defined in claim 14, wherein the correlation detection module comprises a behavioral analysis engine.

16. The security system as defined in claim 15, wherein the behavioral analysis engine determines anomalous user behavior.

17. The security system as defined in claim 14, wherein the correlation detection module comprises threat-detection engines.

18. The security system as defined in claim 17, wherein the threat-detection engines analyze anomalous user behavior to determine if the user behavior represents a specific type of threat.

19. The security system as defined in claim 14, wherein the adaption module determines an initial profile of acceptable behavior during an initialization period.

20. The security system as defined in claim 14, wherein the correlation engine evaluates results from multiple threat-detection engines to determine if there is a threat pattern present.

21. The security system as defined in claim 14, further comprising a security policy module adapted to provide policies to the collaborative detection module to assist in identification in anomalous user behavior.

22. The security system as defined in claim 14, further comprising a security policy module adapted to provide policies to the correlation engine to assist in determining if there is a threat pattern present.

23. The security system as defined in claim 14, further comprising a security policy module adapted to provide a type of responsive action the security system is to take in response to a particular threat pattern.

24. A collaborative detection module comprising:
a behavioral analysis engine adapted to evaluate users interaction with an application, to compare the interaction with a profile of acceptable behavior, and to identify anomalous user behavior; and
at least one threat-detection engine adapted to be notified of anomalous user behavior by the behavioral analysis engine, wherein when notified the at least one threat-detection engine analyzes the user behavior to determine if it is a pattern of behavior indicative of a threat associated with the at least one threat-detection engine and to output a result of the analysis.

25. The collaborative detection module as defined in claim 24, further comprising receiving the profile of acceptable behavior from an adaption module.

26. The collaborative detection module as defined in claim 25, wherein the profile of acceptable behavior is modified as users continue to interact with the application.

27. A correlation engine comprising:
a first input adapted to receive threat-detection results and to correlate the results to determine if there is a threat pattern;
a second input adapted to receive security policies and to determine an appropriate response if there is a threat pattern; and
an output adapted to provide correlation results to an event database.

28. The correlation engine as defined in claim 27, wherein the threat-detection results are received from a plurality of threat-detection engines.

29. The correlation engine as defined in claim 28, wherein the threat-detection results from at least two of the plurality of threat-detection engines are correlated to determine if there is a threat pattern.

30. An adaption module comprising:
an input adapted to monitoring traffic of users as the user interacts with a Web application;
a profiler adapted to identify interaction between the user and the application thereby determining a profile of acceptable behavior of a user while interacting with the application, wherein the profile is modified if additional acceptable behavior is identified; and
an output adapted to communicate the profile to a security profile module.
